(19) United States
(12) Patent Application Publication
(10) Pub. No.: US 2002/0159681 A1
(43) Pub. Date: Oct. 31, 2002

(54) Protected optical crossconnect

(76) Inventor: Robert I. MacDonald, Manotick (CA)

Correspondence Address: Juliusz Szereszewski, JDS Uniphase Corporation, Intellectual Property Dept., 570 West Hunt Club Road, Nepean, ON, K2G 5W8, CA

(21) Appl. No.: 10/153,592

(22) Filed: May 24, 2002

Related U.S. Application Data
(63) Continuation-in-part of application No. 09/775,505, filed on Feb. 5, 2001.
(60) Provisional application No. 60/293,197, filed on May 25, 2001.

(51) Int. Cl. G02B 6/26

(52) U.S. Cl. 385/17

(57) ABSTRACT

An optical protected crossconnect for switching a plurality of input optical signals to a plurality of locations in a non-blocking manner has at least three stages (a first external stage, at least one center stage and a second external stage), the first external stage optically coupled to the second external stage through the at least one center stage, with at least one connection between each module in the first and second external stages and center stage modules, the first external stage having a number of modules. Each module has a plurality of external input/output ports, at least one protection port, a plurality of redundancy means, each redundancy means optically coupled to one of the input/output ports, and a plurality of second ports for coupling input signals from the external module to a center stage or from coupling output signals from the center stage to the external module. Each redundancy means (switch or coupler/combiner) is also coupled to a protection port of another external module of the external stage. This arrangement provides efficient “1 for 1” redundancy protection of external and central stages of the optical crossconnect.

### RELATED APPLICATIONS

This application claims priority of U.S. provisional application No. 60/293,197 filed May 25, 2001 and is a continuation-in-part of U.S. patent application Ser. No. 09/775,505 filed Feb. 05, 2001.

### TECHNICAL FIELD

This invention relates to optical switches, more particularly to multi-stage non-blocking optical switches having failure protection.

### BACKGROUND OF THE INVENTION

An optical crossconnect (OXC) is a device that can direct any of M incoming optical signals to any of N outgoing optical ports. If the crossconnect is “non-blocking”, it is capable of connecting any incoming optical signal to any unused output port irrespective of other connections.

Optical crossconnects are used in optical networks to route optical signals that may either be individual signals, or entire sets of optical wavelength division multiplexed signals. Because of the high cost of interrupting even a single optical signal carrying information at a high data rate it is usually required that optical crossconnects be protected against failure. In the event of the failure of an existing path through a crossconnect it must be possible to provide an alternative path quickly and without affecting other connections. Furthermore, it is desirable that in the event of a failure the failed component of the crossconnect can be repaired or replaced without affecting the ability to route signals or the integrity of any existing connections.

Optical crossconnects may be fabricated using optical switching devices capable of providing the entire routing capability of M inputs to N outputs (the devices known as an M×N “switch” or “matrix”). To provide protection against failure, two single stage M×N matrices, with 1×2 “protection” switches (or power dividing couplers) at each input and output port, may be used to construct a M×N crossconnect. Such a prior art protected crossconnect is shown in FIG. 1. The protection switches direct the incoming and outgoing signals to one or the other of the M×N matrices. In the event of a failure in one M×N matrix, all signals are routed through the other. Since either M×N matrix can provide the entire M×N connection capability required in the protected crossconnect, either one can be used while the other is replaced. The only impact of a failure is the interruption caused by the action of the protection switches and the unprotected condition of the crossconnect while the failed component is being replaced. Such a protected crossconnect is said to have “1 to 1” protection because the M×N matrix that effects the routing is fully redundant.

Multiple stage crossconnects are also known. In multistage M×N crossconnects, the component matrices (modules) can have fewer than M inputs and N outputs, for example P<M inputs and Q<N outputs. Such smaller matrices can be easier to fabricate. However, care must be taken that the component matrices are correctly interconnected to provide nonblocking performance. In particular, the multiple stage design of Clos (1953) is guaranteed to be nonblocking. A typical Clos crossconnect is shown in FIG. 2. Note that each component switch of the central column of modules (stage) has at least one connection to each of the component switches of the input column and the output column. It is essential for non-blocking performance of this design that the number of nonblocking connections between the matrices (modules) of the central stage and each of the modules of the first and second (input and output) stage be equal to or greater than the sum of the number of inputs P of one of the switch components of the input column and the number of outputs Q of one of the switch components of the output column, less one (i.e.P+Q−1). Typically, the crossconnect is symmetric, whereupon the condition is that the central column contain at least 2P−1 component switches. In the following description P=Q is assumed for simplicity, without relinquishing generality.

Optical M×N switching matrices are constructed by various methods. For example, incoming signals may be deflected into the outgoing paths by mirrors that are moved into the signal path to redirect the light. Such switches have a movable mirror for every possible path which amounts to M×N mirrors. Another type of M×N optical switch uses devices capable of directing an optical beam, for example steerable mirrors. In switches of this type there are M mirrors capable of steering the M input signals to N other mirrors, each associated with one of the N outputs, thus M+N mirrors. In matrices of this type, it may be necessary to monitor periodically or continuously an associated pilot beam in order to ensure that the mirrors are correctly aligned. While pilot beams may be, and often are, provided by the matrix itself, this could lead to excessive cost of multistage protected crossconnects. A pilot beam injected at the input of the crossconnect can be monitored in turn at each matrix associated with the established path. The number of pilot beams required, with associated coupling devices, may thus be greatly reduced. Furthermore a signal injected on the pilot tone can be used to identify the entire path.

It has been noted by L. Wosinska et al. (Journal of Lightwave technology, Vol. 19, No. 8, Aug. 2001) that the central column is protected if there is provided at least one more than (2P−1) component matrices therein, each matrix (module) of the central column having at least one connection to each of the matrices of the input column and the output column as before. Such a crossconnect is shown in FIG. 3. Protection of the central column is evident because the Clos architecture for a crossconnect is known to be fully nonblocking under the condition that there is one less matrix in the central column than has been provided in this case. Therefore, the failure of any one of the central column matrices still leaves the overall multistage crossconnect in a nonblocking condition, able to complete any connection between inputs and outputs that are not already in use. This way of providing protection is attractive because only a single relatively small P×P redundant matrix is required to protect several (2P−1) others of the same size. Such protection is termed “N for 1” where N represents the number of components protected by the one redundant one. However, only the central stage is protected by the means shown in FIG. 3.

It is an object of the current invention to provide a method of protecting the input and output columns of multistage switches with “N for 1” redundancy, yielding a crossconnect with a protection level equal to or greater than the “1 for 1” design.

### SUMMARY OF THE INVENTION

In accordance with one aspect of the invention, there is provided an optical protected crossconnect for switching a plurality of input optical signals to a plurality of locations in a non-blocking manner, the crossconnect comprising:

a first external stage, at least one center stage and a second external stage, the first external stage optically coupled to the second external stage through the at least one center stage, with at least one connection between each module in the first and second external stages and center stage modules, the first external stage having a number of modules, each module comprising

a plurality of external input/output ports,

at least one protection port,

a plurality of redundancy means, each redundancy means optically coupled to one of the input/output ports, and

a plurality of second ports for coupling input signals from the external module to

a center stage or from coupling output signals from the center stage to the external module, wherein each redundancy means is also coupled to a protection port of another external module of the external stage.

It is to be understood that the crossconnect can work in both directions, whereby the input ports can function as output ports and vice versa. For this reason, the first external stage is defined herein as having bi-functional input/output ports.

In one embodiment, each protection port has a protection switch optically coupled thereto, and each protection switch is coupled to at least one redundancy means of another external module of the external stage.

Preferably, the number of second ports on any of the external modules is at least 2 (P+1), where P is the number of input/output ports on that module, and each of the second ports is coupled to a module of a center stage.

Preferably, but not necessarily, each module of the first external stage is functionally identical with each module of the second external stage.

In one embodiment, each redundancy means in an external stage is a 1×n switch, n being at least 2, that is optically coupled to an input port, and a protection port of another external module of the same external stage. Alternatively, the redundancy means may be a power divider (or combiner, in a second external stage), defining at least two optical paths for an optical signal. In order to avoid interference problems, a polarization rotator may be provided in one of the at least two optical paths of the power divider (splitter) for rotating the polarization of the optical signal in the one path.

The crossconnect may further comprise means for combining an optical pilot signal, typically with a different wavelength, with one of the input signals before the first external stage, and means for retrieving the pilot signal after each stage for control of the respective stage.

In accordance with another aspect of the invention, there is provided a method of repairing or replacing a failed module in one of the external stages of the crossconnect as defined above, the method comprising:

routing each signal from the failed module to another module of the same stage,

establishing connections through the crossconnect for the routed signals to original destinations in the other external stage, and

repairing or replacing the failed module.

### BRIEF DESCRIPTION OF THE DRAWINGS

Exemplary embodiments of the invention will now be described in conjunction with the drawings, in which:

FIG. 1 is a schematic diagram of a prior art M×N crossconnect with 1:1 protection,

FIG. 2 is schematic diagram of a prior art 4×4 Clos three stage matrix switch;

FIG. 3 is a schematic diagram of a prior art overconnected Clos three stage matrix switch having one more than the minimum number of center stage modules, to provide protection of the center stage;

FIG. 4 is a schematic general diagram of a multistage crossconnect with input and output stage protection as well as center stage protection using protection switches,

FIG. 4a is a more detailed partial diagram of the crossconnect of FIG. 4,

FIG. 5 is a schematic diagram of a fully protected multistage crossconnect without protection switches,

FIG. 5a is a more detailed partial diagram of the crossconnect of FIG. 5,

FIG. 6 is a schematic diagram of a fully protected multistage crossconnect with protected pilot signals, and

FIG. 7 illustrates a protected switch using power dividers and recombiners for protection and polarization rotators to permit simultaneous setup of alternate paths.

### DETAILED DESCRIPTION OF EMBODIMENTS OF THE INVENTION

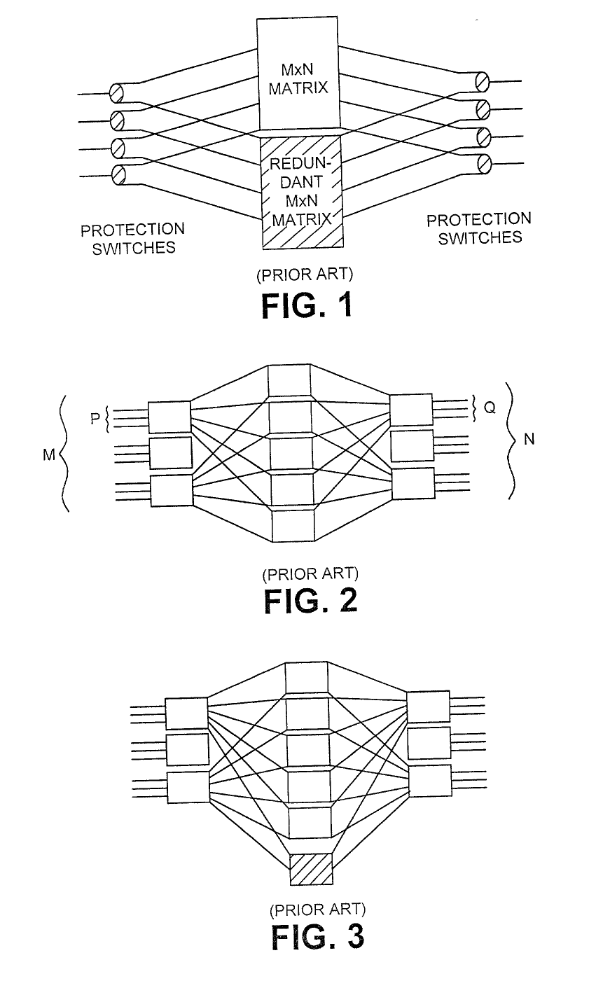

As indicated above, FIGS. 1, 2 and 3 illustrate prior art switching designs which, while serving their intended functions, do not protect satisfactorily the input and output stages, or columns, of multistage switches.

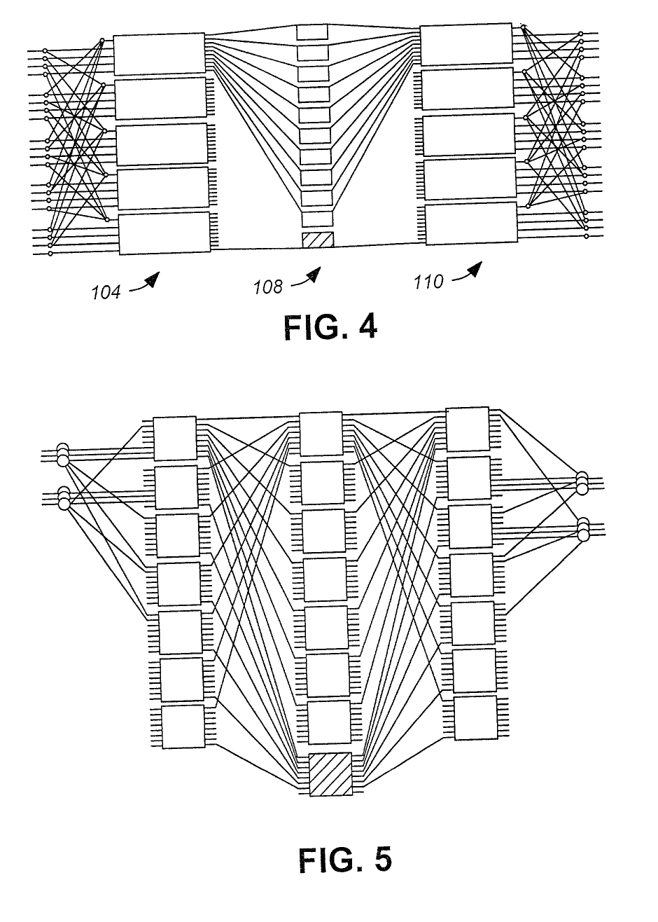

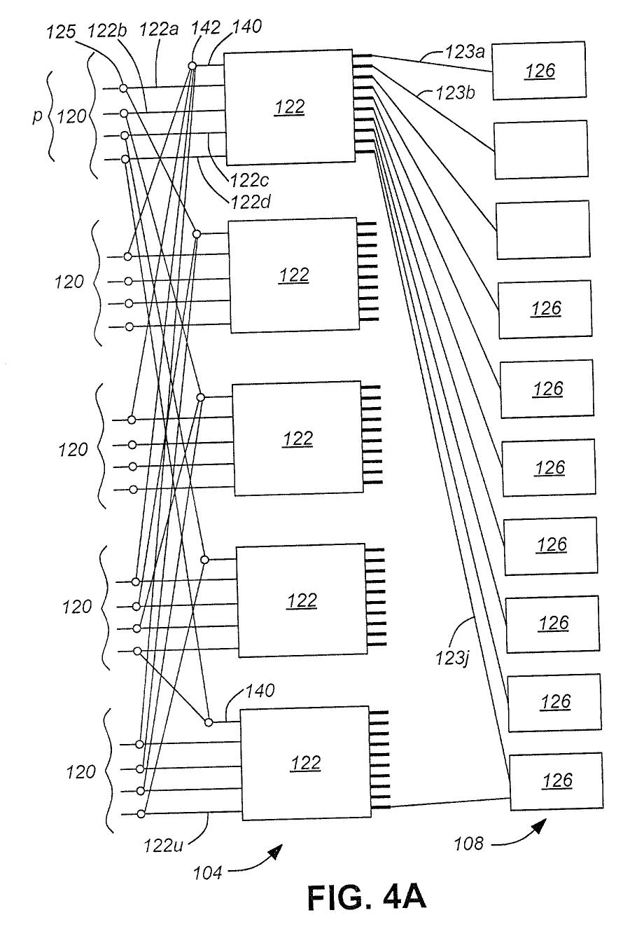

The present invention attempts to solve this problem. An exemplary design of an improved crossconnect, with a protection of input and output columns, is shown in FIGS. 4 and 4a. Each of the incoming connections to each matrix of the input column is provided with a protection switch or coupler that also connects to at least a second, different matrix of the input column. Similar protection switches or couplers and connections are provided in the output column. Thereby each incoming signal has the possibility of reaching at least two different input matrices, and correspondingly at the output each output signal has the possibility of emerging from at least two output matrices. One method of arranging these protection connections is shown in FIG. 4. Each input and output matrix is provided with one or more extra external connections to which a selector switch is connected. This switch can select which incoming protection signal is to be handled. The condition for full protection is that each of the inputs to a particular matrix has at least one protection connection to a different one of the other matrices of the column.

The following symbols are used throughout the description:

P—number of input/output (external) ports in an external module,

M—total number of external signal ports carried by the crossconnect,

Z—number of protection ports per external module.

FIG. 4a shows a single external stage 104 in detail, coupled to an overconnected center stage 108, shown generally. The external stage has 5 external modules 120, each module encompassing a crossconnect submatrix (module) 122 having P=4 external input/output ports 122 a-d and Z (in this case one) protection port 140 having a protection switch (also termed selector switch) 142 which will be described in more detail below. The number Z of protection ports 140 and corresponding switches 142 may be greater than one per module. Each external module 120 is interconnected to at least one other external module 120 via the protection, or rerouting, port 140. To provide this interconnection, each input/output port 122a . . . 122d has a 1×n redundancy switch or coupler, in the specific case a 1×2 switch 125. Each redundancy switch 125 provides optical coupling of an input signal either to the respective external module 120 for switching to any second port 123a . . . 123j, or to a rerouting port 140 on another external module 120. In accordance with the “protected Clos” principle, the number of the second ports 123a . . . 123j is 10 which is 2(P+Z), P being 4 and Z being 1. Alternatively, a 1×n redundancy switch 125, where n is greater than 2, can couple a first port 122a . . . 122d to a rerouting port 140 on more than one other external module 122.

For clarity, the term “module” as applicable to the present invention and FIG. 3 encompasses the module 122 with the input/output ports as well as the protection switches and the redundancy switches.

In the embodiment illustrated, the entire crossconnect has a dimension 20×20 (M×M), as the protection ports 140 do not serve as input nor output ports. It will also be noted that not all the connections between the switches 125 and 142 are illustrated. Also, only connections between the top input module 120 and the central stage modules 126 are indicated. It will be understood that all such connections are provided in the actual switch matrix.

In the input direction, from the left side of FIG. 4a, each rerouting port 140 comprises an (M/P−1)×1 protection switch 142 for receiving and coupling a signal from one external module 120 into another external module 120 for switching to any second port 123a . . . 123j in an input direction. In an output direction, on the opposite side of the center stage 126, the rerouting ports (not shown) comprise each a 1×(M/P−1) protection switch which can redirect a signal from an external module to an output first port on another external module in a mirror-image configuration relative to the input side.

The center stage 108 comprises ten center stage modules 126. The number of center stage modules 126 is 2(P+Z), i.e. equal to twice the number of input/output first ports 122a . . . 122d and rerouting ports 140 on an external module 122 for supporting an optical connection from each external stage module 122 to each center stage module 126. A second external stage 110 (shown in FIG. 4 but not shown in FIG. 4a) is symmetrical to the first external stage 104.

Further, it is understood that the switch matrix provides bi-directional switching capability. Each external first port 122a . . . 122n or location may launch or receive signals n either direction, independently of other external first ports 122a . . . 122n.

Preferably each stage 104, 108, 110 is comprised of like modules or of functionally identical modules to simplify the construction and maintenance of the crossconnect.

Each module of the input stage (column) is therefore provided with at least one extra input (protection) port in addition to the P input ports of the original design, and corresponding increase occurs in output ports of the output column matrices. For the purpose of designing the protected Clos crossconnect, the number of central stage switches required now becomes 2(P+Z) where Z represents the number of protection ports provided for protection switches on each external module. For simplicity we discuss below the case where Z=1, without relinquishing generality.

In this example the single extra input to each module (matrix) can select from protection connections from inputs of other modules (matrices) of the input stage (column) 104. The condition for full protection is that every input to a particular module has an alternative route through another module. By this means a failure in any of the modules of the input column is protected because all the inputs to such a switch can be rerouted to other modules of the input column (first external stage) 104. A similar provision is made in the output column 110. There must be at least an aggregate of P selector switches on different matrices to accommodate a failed matrix. In the example where z=1 the overall number of input ports is therefore at minimum P*(1+P). Smaller scale protected crossconnects are possible if z>1.

The inventive architecture shown in FIG. 4 and FIG. 4a provides full protection against failure of any component matrix. However the use of 1×n selector switches may be undesirable since they insert an excess loss and represent a third kind of optical switch component in addition to the matrices and 1×2 protection switches or couplers. Furthermore, many optical switching matrices available to be component matrices have symmetric switching capability, of the form n inputs×n outputs. The matrix components of the input and output columns of the crossconnect architectures shown in FIGS. 2-4a are approximately of the form n/2×n, and it would be possible to make a protected switch with z=n/2. When there is a sufficient number of protection ports z on each matrix it is possible to eliminate the 1×n selector switches shown in FIG. 4 and 4a.

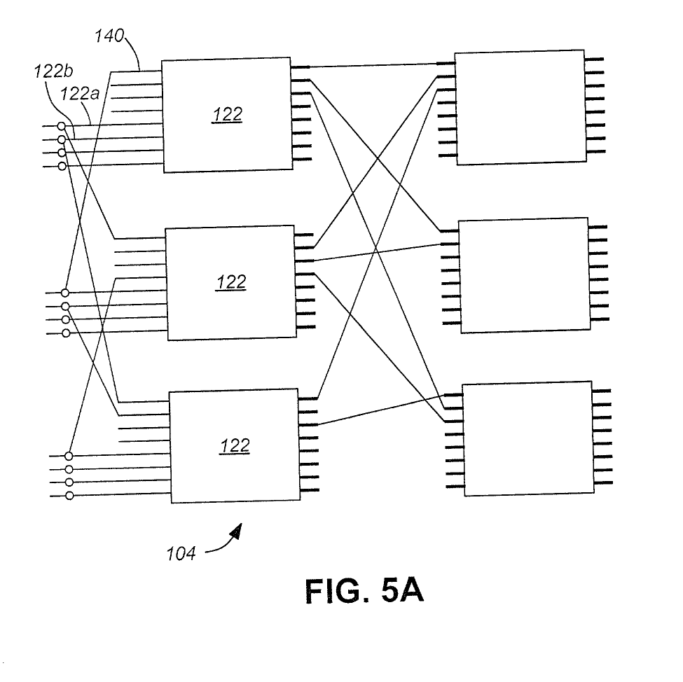

A second embodiment of the fully protected three stage crossconnect is shown in FIG. 5 and FIG. 5a. The crossconnect has P inputs associated with each input stage matrix, and 1×2 redundancy switches or couplers 135 on each input port that can deliver the associated input to the associated input stage module, or alternatively to one of the extra ports 140 of one of the other input stage modules. Optimally, each protection connection for the P inputs to a single module is delivered to a protection port of a different matrix. To ensure that the crossconnect remains nonblocking even when protecting from a failure, multistage crossconnect must be designed to be nonblocking when for P+1 inputs to each input module. The number of central stage modules must therefore be 2(P+1), or 2P+2. The size of the component modules required for the input and output stages is therefore at least 2(P+1)×2(P+1). Since at least one protection input must be provided on each matrix for every other matrix the total number of input ports on one of the input matrices must be at least P+(M/P−1). The limiting overall size M of this form of protected crossconnect is therefore given by solving 2(P+1)=P+(M/P+1) for M, to obtain M=<P².

For a single connection, it is sometimes desirable to establish both a primary route and an alternative route through the crossconnect at the same time. Optical power may be divided between primary and standby route by a power dividing coupler used as the protection 1×n (e.g. 1×2) device, and the two routes may be recombined using a second such coupler as the 2×1 protection device at the output.

However, it is not desirable to split optical signals, pass them through different paths, and recombine them because very small differences in the path lengths can lead to interference between the recombined signals. One method by which this can, however, be accomplished is to rotate the polarization of one of the signals by 90 degrees. By maintaining the rotated polarization state through to the recombining coupler, it can be assured that the signals can be combined without interference. To this effect, a polarization rotator 144 is installed on each line 146 connecting a redundancy coupler of one external module 122 to a protection port on another external module 122.

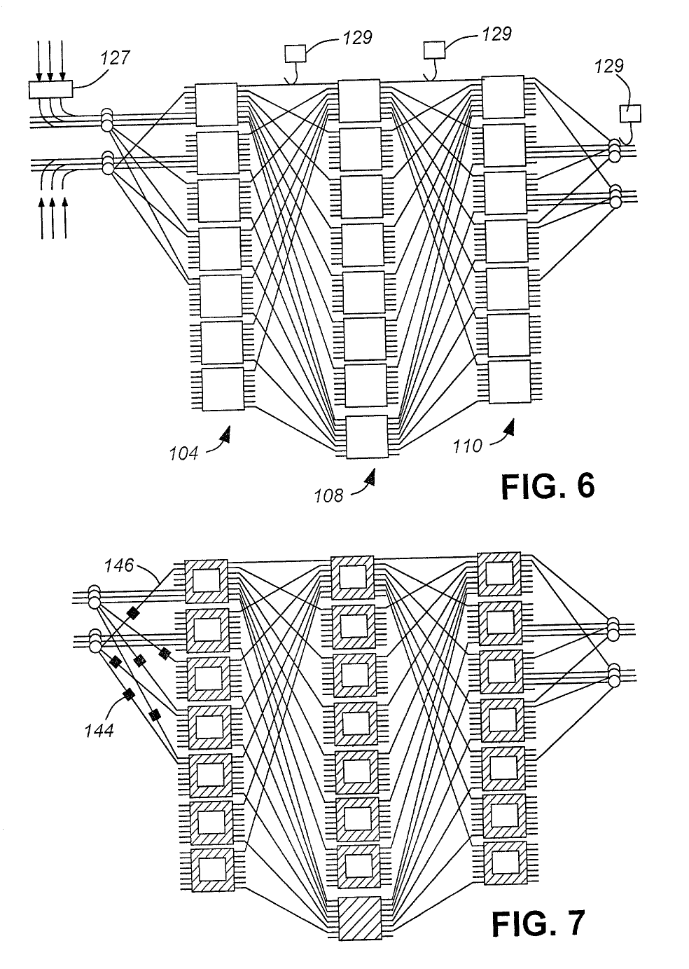

As can be seen in FIG. 6, it is possible to introduce a pilot signal into one of the input signals to monitor the performance of the crossconnect. Preferably, the wavelength of the pilot signal is different than the wavelength of the input signal combined with the pilot signal. The pilot signals are introduced e.g. into the input lines 122a, 122b . . . from a transmitter 127 via a coupler, and the pilot signals are monitored after the first external stage 104, the center stage 108 and the second external stage 110 by means of monitors, also through couplers.

1. A protected crossconnect for switching a plurality of optical signals to a plurality of locations in a non-blocking manner comprising:
a first external stage, at least one center stage and a second external stage, the first external stage optically coupled to the second external stage through the at least one center stage, each of the stages having a number of modules with at least one connection between each module in the first and second external stages and center stage modules,
each module in the first or the second external stage comprising
a plurality of external input/output ports,
at least one protection port,
a plurality of redundancy means, each redundancy means optically coupled to one of the input/output ports, and
a plurality of second ports for coupling input signals from the external module to a center stage or from coupling output signals from the center stage to the external module,
wherein each redundancy means is also coupled to a protection port of another external module of the external stage.

2. The crossconnect of claim 1 wherein each protection port has a protection switch optically coupled thereto, and each protection switch is coupled to at least one redundancy means of another external module of the external stage.

3. The crossconnect of claim 1 wherein the number of second ports on any of the external modules is at least 2(P+1), where P is the number of input/output ports on that module, and each of the second ports is coupled to a module of a center stage.

4. The crossconnect of claim 1 wherein each module of the first external stage is functionally identical with each module of the second external stage.

5. The crossconnect of claim 1 wherein each redundancy means in an external stage is a 1×n switch, n being at least 2, that is optically coupled to an input port, and a protection port of another external module of the same external stage.

6. The crossconnect of claim 1 wherein the redundancy means is a switch.

7. The crossconnect of claim 1 wherein the redundancy means is a power divider or combiner defining at least two optical paths for an optical signal.

8. The crossconnect of claim 7 further comprising a polarization rotator in one of the at least two optical paths for rotating the polarization of the optical signal in the one path.

9. The crossconnect of claim 1 further comprising means for combining an optical pilot signal with one of the input signals before the first external stage, and means for retrieving the pilot signal after the first external stage and one or more of the subsequent stages.

10. The crossconnect of claim 9 wherein the pilot signal has a different wavelength than the input signal that is combined with the pilot signal.

11. A module for use in a switch matrix for switching a number of optical signals to a plurality of locations in a non-blocking manner, the module comprising
a number of external input/output ports,
Z protection ports having each a protection switch optically coupled thereto, where Z is at least one,
a plurality of redundancy means, each optically coupled to one of the input/output ports, and
a number of second ports for coupling input signals to said plurality of locations,
wherein each redundancy means is coupled to at least one protection port of another external module of the external stage.

12. In a protected crossconnect for connecting a number of input signals to predetermined destinations, the crossconnect having a first external stage, at least one center stage and a second external stage, the first external stage optically coupled to the second external stage through the at least one center stage, a method of repairing or replacing a failed module in one of the external stages, comprising:
routing each signal from the failed module to another module of the same stage,
establishing connections through the crossconnect for the routed signals to
original destinations in the other external stage, and
repairing or replacing the failed module.
